(19) United States
(12) Patent Application Publication
(10) Pub. No.: US 2022/0334734 A1
(43) Pub. Date: Oct. 20, 2022

(54) INFORMATION PROCESSING SYSTEM AND MEMORY SYSTEM

(71) Applicant: Kioxia Corporation, Tokyo (JP)

(72) Inventor: Hisashi FUJIKAWA, Ebina Kanagawa (JP)

(21) Appl. No.: 17/583,019

(22) Filed: Jan. 24, 2022

(30) Foreign Application Priority Data
Apr. 20, 2021 (JP) 2021-070956

(51) Int. Cl. G06F 3/06; G06F 21/31; G06F 21/60

(52) U.S. Cl. CPC G06F 3/0622; G06F 3/0659; G06F 3/0679; G06F 21/31; G06F 21/602

(57) ABSTRACT

An information processing system includes a host and a memory system. A processor of the host is configured to: determine a logical address of read data and a size of the read data; prepare third information related to the read data other than the logical address of the read data and the size of the read data, the third information being information necessary for the memory system to transmit the read data to the host; and transmit, to the memory system, a command requesting to transmit the read data. A memory controller of the memory system is configured to, in response to receiving the command from the host, transmit a request for the third information to the host. The processor of the host is further configured to, in response to receiving the request from the memory system, transmit the third information to the memory system. The memory controller of the memory system is further configured to, by using the third information, acquire the read data from a nonvolatile memory and transmit the acquired read data to the host, without receiving another command from the host.

### CROSS-REFERENCE TO RELATED APPLICATIONS

This application is based upon and claims the benefit of priority from Japanese Patent Application No. 2021-070956, filed on Apr. 20, 2021; the entire contents of which are incorporated herein by reference.

### FIELD

Embodiments described herein relate generally to an information processing system and a memory system.

### BACKGROUND

A memory system connected to a host processes a transaction in response to a request from the host.

### BRIEF DESCRIPTION OF THE DRAWINGS

FIG. 1 is a diagram illustrating the configuration of an information processing system according to a first embodiment;

FIG. 2 is a block diagram illustrating an example of a functional configuration executed by a memory controller of a memory system according to the first embodiment;

FIG. 3 is a diagram illustrating a header portion of a Universal Flash Storage (UFS) protocol information unit (UPIU) used in the first embodiment;

FIG. 4 is a diagram for explaining attributes of the command used in the first embodiment;

FIG. 5A is a diagram illustrating a command having a Read attribute used in the first embodiment;

FIG. 5B is a diagram illustrating a command having a Write attribute used in the first embodiment;

FIG. 5C is a diagram illustrating a command having both a Read attribute and a Write attribute used in the first embodiment;

FIG. 6 is a sequence diagram illustrating an operation of the information processing system according to the first embodiment;

FIG. 7 is a sequence diagram illustrating an operation of an information processing system according to a comparative example to the first embodiment;

FIG. 8 is a sequence diagram illustrating an operation of an information processing system according to a second embodiment; and

FIG. 9 is a sequence diagram illustrating an operation of an information processing system according to a comparative example to the second embodiment.

### DETAILED DESCRIPTION

According to a present embodiment, an information processing system includes a host including a processor and a memory system connected to the host, the memory system including a nonvolatile memory and a memory controller configured to control the nonvolatile memory. The processor of the host is configured to: determine a logical address of read data and a size of the read data; prepare third information related to the read data other than the logical address of the read data and the size of the read data, the third information being information necessary for the memory system to transmit the read data to the host; and transmit, to the memory system, a command requesting to transmit the read data. The memory controller of the memory system is further configured to, in response to receiving the command from the host, transmit a request for the third information to the host. The processor of the host is further configured to, in response to receiving the request from the memory system, transmit the third information to the memory system. The memory controller of the memory system is further configured to, by using the third information, acquire the read data from the nonvolatile memory and transmit the acquired read data to the host, without receiving another command from the host.

An information processing system according to embodiments will be described below in detail with reference to the accompanying drawings. Note that the present invention is not limited by these embodiments.

### First Embodiment

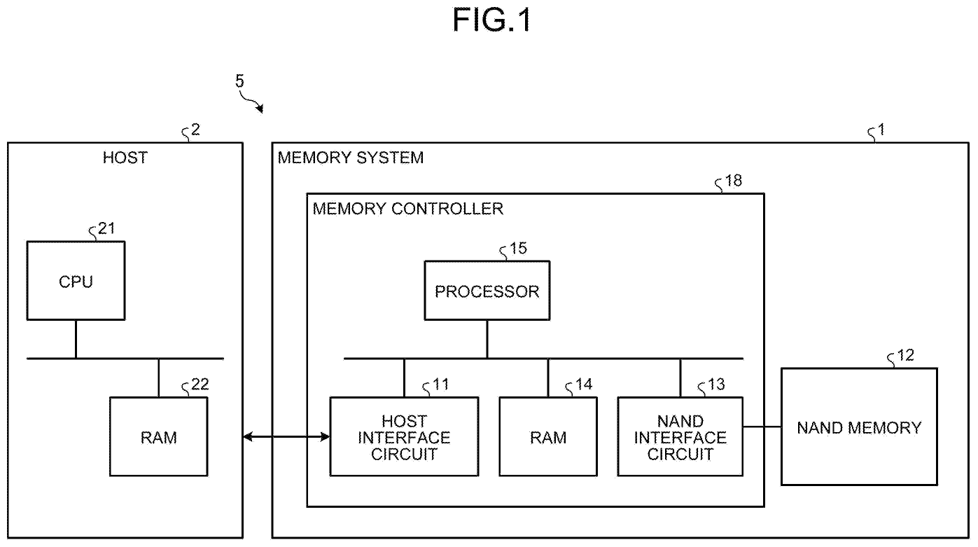

FIG. 1 is a diagram illustrating an example of the configuration of an information processing system 5 according to a first embodiment. The information processing system 5 includes a memory system 1 and a host 2. The memory system 1 is, for example, a Universal Flash Storage (UFS) device or a solid state drive (SSD). In the following, a case where the memory system 1 includes a NAND type flash memory (hereinafter referred to as NAND memory) as a non-volatile memory will be described by way of example.

The host 2 is, for example, a central processing unit (CPU), a personal computer, a portable information device, a server, or other information processing devices. The host 2 includes, for example, a CPU 21 and a random access memory (RAM) 22. The CPU 21 and the RAM 22 may be connected via a bus. The CPU 21 is, for example, at least one processor. The CPU 21 controls various components of the host 2. The RAM 22 is, for example, a volatile memory. The RAM 22 may be a dynamic random access memory (DRAM) or a static random access memory (SRAM). The CPU 21 transmits an access command to the memory system 1.

The memory system 1 is configured to be connectable to the host 2. Any interface standard may be adopted as an interface standard for communication between the memory system 1 and the host 2. Two or more hosts 2 may be simultaneously connected to the memory system 1. The host 2 and the memory system 1 may be connected via a network.

The memory system 1 transmits and receives data to and from the host 2 in response to an access command from the host 2.

The memory system 1 includes a NAND memory 12 and a memory controller 18. The memory controller 18 is configured as, for example, a system-on-a-chip (SoC). Each function of the memory controller 18 may be realized by dedicated hardware, a processor executing a program (e.g., firmware), or a combination thereof. The memory controller 18 includes a host interface circuit 11, a NAND interface circuit 13, a RAM 14, and a processor 15.

The processor 15 is, for example, one or more processors. The processor 15 controls the memory system 1 by executing a program stored in a predetermined location in the memory system 1. The storage location of the program is freely designed. For example, the program may be stored in the NAND memory 12 and loaded into the RAM 14 at startup of the memory system 1. The processor 15 executes the program loaded in the RAM 14. The control of the memory system 1 includes a plurality of processes.

The host interface circuit 11 is an interface device for the memory system 1 to communicate with the host 2. For example, the host interface circuit 11 transfers user data between the host 2 and the RAM 14 under the control of the processor 15.

The NAND interface circuit 13 is an interface device for accessing the NAND memory 12. The NAND interface circuit 13 transfers user data or management information between the RAM 14 and the NAND memory 12 under the control of the processor 15.

The NAND memory 12 is a non-volatile storage medium that functions as a storage. The NAND memory 12 may include one or more chips.

The RAM 14 is a storage medium for temporarily storing data. As the RAM 14, for example, a type of storage medium faster than the NAND memory 12 may be adopted. As the RAM 14, for example, a volatile or non-volatile storage medium may be adopted. The RAM 14 is, for example, a DRAM, an SRAM, a ferroelectric RAM (FeRAM), a magneto-resistive RAM (MRAM), or a phase-change memory (PCM).

Conventionally, a logical-to-physical address conversion table (L2P table) for associating logical addresses and physical addresses of a nonvolatile memory in a memory system is managed in the memory system. However, since the size of the L2P table is usually about 1/500 to 1/1000 of the storage capacity of the memory system, it is not practical to store all of the L2P tables in a RAM or other areas in a memory controller of the memory system. Consequently, the L2P table is stored in a non-volatile memory such as a NAND memory and read out as needed. This requires a latency and deteriorates a performance (especially of read operations) of the memory system. However, if mapping data of the L2P table for data to be read can be transmitted from the host simultaneously with a read command, the latency for reading the L2P table can be reduced and the improved performance can be achieved.

The Host Performance Booster Extension Ver. 1.0 (HPB 1.0) standard, which is a part of the UFS standard and was standardized in early 2020, defines that a memory (e.g., DRAM) in a host may store part of the mapping data of the L2P table. When the host that conforms to the HPB 1.0 standard transmits a read command, the mapping data for read data (i.e., data to be read) is simultaneously transmitted to a memory system, thereby reducing the overhead of referring to the L2P table internally by the memory system. This enables speeding up of read operations, especially of random read operations.

The UFS standard employs a client-server protocol. This means that the memory system cannot transmit commands to the host on its own, and any communication between the host and the memory system should be initiated by the host. Thus, all the information necessary for the operation of the memory system should be included in information transmitted by the host. Information is transmitted between the host and the memory system by using, for example, a packet called a UFS protocol information unit (UPIU). An example of the information is a command transmitted by the host. Hereinafter, the UPIU to transmit the command will be referred to as a COMMAND UPIU.

The HPB 1.0 standard defines that the mapping data is included in a COMMAND UPIU and transmitted from a host to a memory system. However, unfortunately, the mapping data included in the COMMAND UPIU has a defined size. For example, in the case of the HPB 1.0 standard, it is defined that the COMMAND UPIU may include the mapping data of 8 bytes. This size of mapping data corresponds to one logical block (e.g., 4 KB) of read data. This limits the size of read data that can be requested by one read command with the mapping data included therein up to 4 KB. However, in many cases, read commands from the host request read data larger than 4 KB. Therefore, it is preferable to allow the size of read data that can be requested by one read command with the mapping data included therein to be 8 KB or more. Here, note that the size of read data should be an integer multiple of the size of the logical block (e.g., 4 KB).

In the present embodiment, the memory system 1 efficiently processes a request from the host 2 by executing a command based on the HPB standard. The command based on the HPB standard here refers to a command defined in the HPB standard at present and in the future.

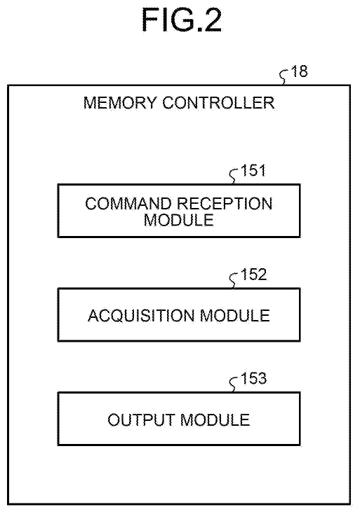

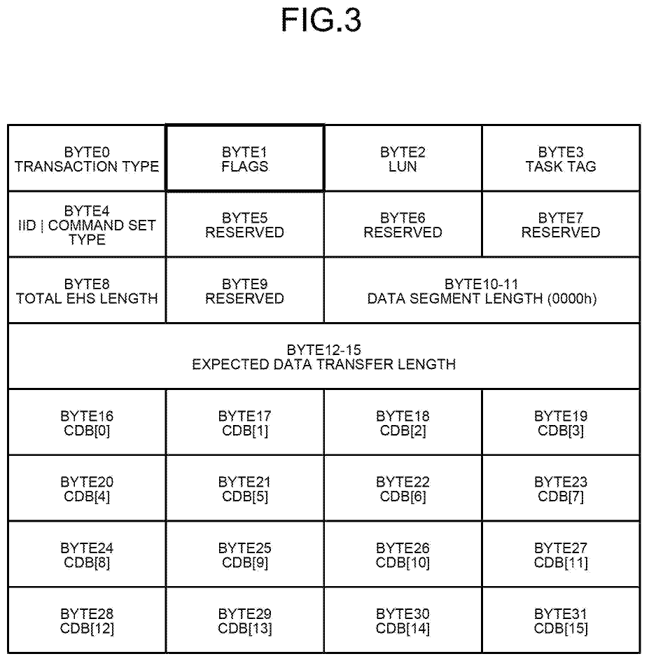

FIG. 2 is a block diagram illustrating an example of a functional configuration executed by the memory controller 18 of the memory system 1. As illustrated in FIG. 2, the memory controller 18 includes a command reception module 151, an acquisition module 152, and an output module 153. The command reception module 151 receives a command transmitted from the host 2. Here, a header portion of a UPIU will now be described with reference to FIG. 3.

FIG. 3 is a diagram illustrating the header portion of a UPIU based on the HPB standard. As illustrated in FIG. 3, the header includes 32 bytes (i.e., byte 0 to byte 31) of information.

Among the 32-byte information, byte 0 defines “Transaction Type”. For example, the “Transaction Type” of “00000001” defines that this UPIU is to transmit a command from a host to a memory system. As described above, this type of UPIU is referred to as a COMMAND UPIU. The “Transaction Type” of “00000010” defines that this UPIU is to transmit data from the host to the memory system. This type of UPIU is referred to as a DATA OUT UPIU. The “Transaction Type” of “00100010” defines that this UPIU is to transmit data from the memory system to the host. This type of UPIU is referred to as a DATA IN UPIU. The “Transaction Type” of “00110001” defines that this UPIU is to transmit a ready-to-transfer status from the memory system to the host, which indicates that the memory system is ready to receive data from the host and specifies the size of the data that the memory system can receive at one time. This type of UPIU is referred to as an RTT UPIU. The “Transaction Type” of “00100001” defines that this UPIU is to transmit a response from the memory system to the host, which indicates that the execution of a command is completed in the memory system. This type of UPIU is referred to as a RESPONSE UPIU.

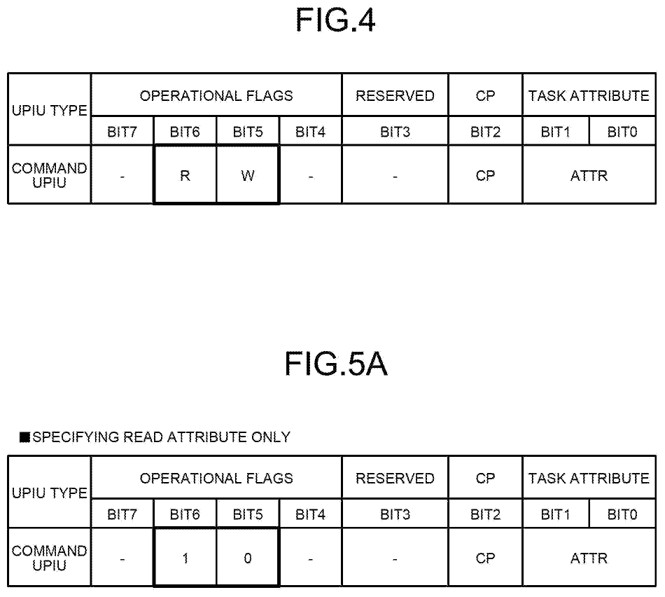

Among the 32-bytes header, byte 1 defines “Flags” field. The “Flags” field in a COMMAND UPIU indicates an attribute of a command transmitted by this COMMAND UPIU. The attributes of the command indicated by the “Flags” field will now be described with reference to FIG. 4. FIG. 4 is a diagram for explaining the attributes of the command. As illustrated in FIG. 4, each bit of some of the 8 bits of “Flags” is assigned an attribute. For example, bit 6 is assigned a Read attribute, and bit 5 is assigned a Write attribute.

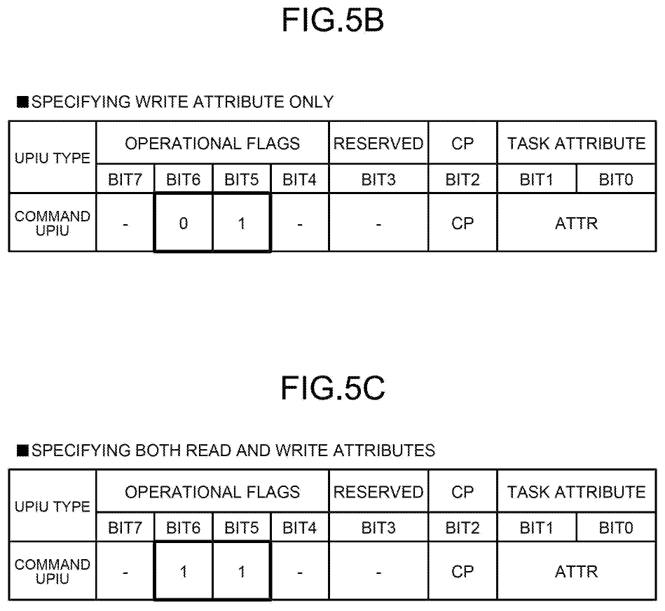

FIG. 5 then illustrates an example of setting of the attribute. As illustrated in FIG. 5A, setting bit 6 to “1” and bit 5 to “0” indicates that this command has a Read attribute. As illustrated in FIG. 5B, setting bit 5 to “1” and bit 6 to “0” indicates that this command has a Write attribute.

As illustrated in FIG. 5C, setting both bit 6 and bit 5 to “1” indicates that this command has both a Read attribute and a Write attribute. The present embodiment uses a command having both the Read attribute and the Write attribute. The command having the two attributes used in the present embodiment requests both a data transmission from the host 2 to the memory system 1 (i.e., in response to the Write attribute), and a data transmission from the memory system 1 to the host 2 (i.e., in response to the Read attribute).

Return to FIG. 2. The command reception module 151 acquires mapping data for read data included in a received command transmitted from the host 2.

The acquisition module 152 acquires the read data from a location of the NAND memory 12 based on the physical address included in the mapping data for the read data acquired by the command reception module 151. The output module 153 transmits the read data acquired by the acquisition module 152 to the host 2.

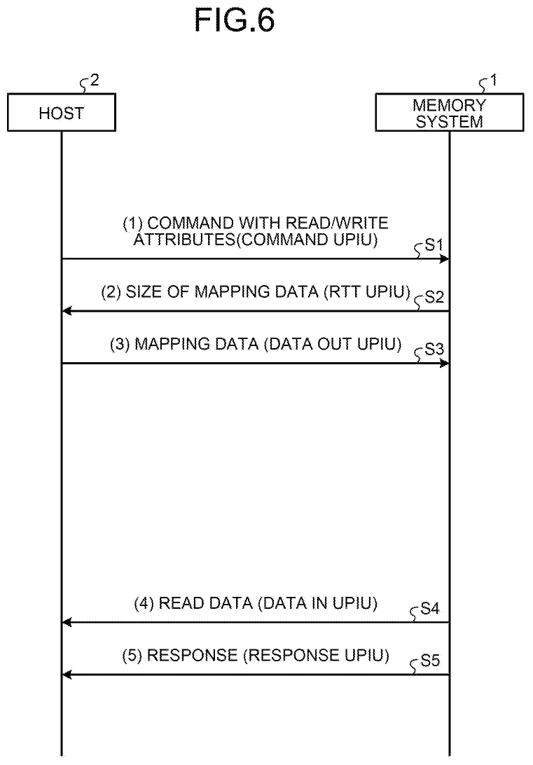

An operation of the information processing system 5 that includes the memory system 1 and the host 2 will be described with reference to FIG. 6. FIG. 6 is a sequence diagram illustrating the operation of the information processing system 5 according to the first embodiment. This operation enables a read operation of 8 KB or more by one command using the mapping data transmitted from the host 2.

Here, it is assumed that the host 2 (specifically, the CPU 21) stores the L2P table of the memory system 1 in the RAM 22. The host 2 first determines a logical address and the size of read data, and transmits a command to the memory system 1 using a COMMAND UPIU (step S1). This command may specify the logical address (e.g., start logical address) and the size of the read data. This command may specify a plurality of logical addresses by the start logical address and the size of the read data. This command has both a Read attribute and a Write attribute as described above. In other words, in the “Flags” field as illustrated in FIG. 5C, both bit 6 and bit 5 are set to “1”. Upon receiving this command, the command reception module 151 of the memory system 1 transmits an RTT UPIU to the host 2 (step S2). The memory system 1 transmits the RTT UPIU to the host 2 to request the mapping data for the read data. As described above, the RTT UPIU specifies the size of data (here, the size of the mapping data) that the memory system 1 can receive at one time.

In response to the RTT UPIU, the host 2 transmits the mapping data for the read data to the memory system 1 using a DATA OUT UPIU (step S3). The mapping data may include a plurality of entries each of which maps one physical address of the NAND memory 12 and one logical address among the plurality of logical addresses specified in the command. If the entire mapping data for the read data exceeds the size specified in the RTT UPIU, the host 2 divides the entire mapping data such that the size of the mapping data to be transmitted to the memory system 1 does not exceed the specified size and transmits the divided mapping data. Thus, the memory system 1 can surely receive the mapping data for the read data from the host 2 by specifying the size that the memory system 1 can receive at one time. The command reception module 151 of the memory system 1 acquires the mapping data for the read data. The acquisition module 152 acquires the read data from a location of the physical address indicated by the mapping data. The output module 153 transmits the read data acquired by the acquisition module 152 to the host 2 using a DATA IN UPIU (step S4). The command reception module 151 of the memory system 1 transmits a response using a RESPONSE UPIU to complete the process (step S5).

As described above, by using one command, the host 2 transmits mapping data for read data to the memory system 1, and the memory system 1 then acquires the read data from a location of the physical address indicated by the mapping data, and transmits the read data to the host 2. Thus, the memory system 1 does not need to access the L2P table managed by itself. A read request can efficiently be processed by one command in the information processing system 5.

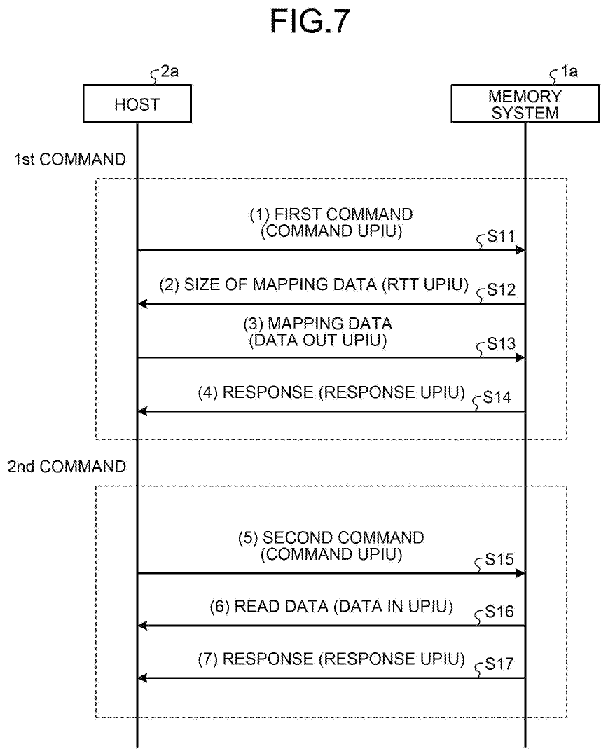

Here, a comparative example will be described. An information processing system 5a according to the comparative example includes a memory system 1a and a host 2a. In the comparative example, a command for transmitting mapping data to the memory system 1a and another command for transmitting read data to the host 2a are used. FIG. 7 is a sequence diagram illustrating an operation of the information processing system 5a according to the comparative example.

Here, it is assumed that the host 2a stores the L2P table of the memory system 1a in its internal RAM. As illustrated in FIG. 7, the host 2a transmits a first command having a Write attribute to the memory system 1a using a COMMAND UPIU (step S11). Note that this first command has a Write attribute but does not have a Read attribute. Upon receiving this command, the memory system 1a transmits an RTT UPIU to the host 2a (step S12). As described above, the RTT UPIU specifies the size of the mapping data that the memory system 1a can receive at one time. In response to the RTT UPIU, the host 2a transmits the mapping data to the memory system 1a using a DATA OUT UPIU (step S13). The memory system 1a then transmits a response using a RESPONSE UPIU to complete the first command (step s14).

The host 2a then newly transmits a second command having a Read attribute to the memory system 1a using a COMMAND UPIU (step S15). The memory system 1a acquires the read data from a location of the physical address indicated by the mapping data that has been received in step S13. The memory system 1a then transmits the read data to the host 2a using a DATA IN UPIU (step S16). The memory system 1a finally transmits a response to the host 2a using a RESPONSE UPIU to complete the second command (step S17).

In the method of the comparative example, since the mapping data is transmitted not as auxiliary information of a COMMAND UPIU but as write data in response to an RTT UPIU, a large size of read data, which results in a large size of the mapping data, can be handled. However, there are the following problems.

First, one read request requires two commands, which consume twice the command queue of the memory system 1a. Generally, the larger the number of commands that can be queued, the better read performance can be expected. Thus, the impact of halving the number of commands that can be queued is significant.

Second, the UFS standard allows commands of the same priority to be executed in an out-of-order manner. However, to execute the first and second command as described above, the memory system 1a needs to guarantee the execution order of these two commands. That is, the memory system 1a needs to execute the first command first, and then execute the second command. Such a requirement may increase the complexity of processes and deteriorate the performance.

On the other hand, according to the first embodiment, transmission/reception of the mapping data and transmission/reception of the read data are executed by one command. Therefore, the consumption of the command queue can be reduced as compared with the comparative example. Further, the processing for guaranteeing the execution order between commands is not required, and the processing can be performed efficiently.

### Second Embodiment

In the first embodiment, the case has been described where a command having both a Write attribute and a Read attribute is used to transmit/receive mapping data and read data. In a second embodiment, such a command is used to transmit/receive authentication data and read data.

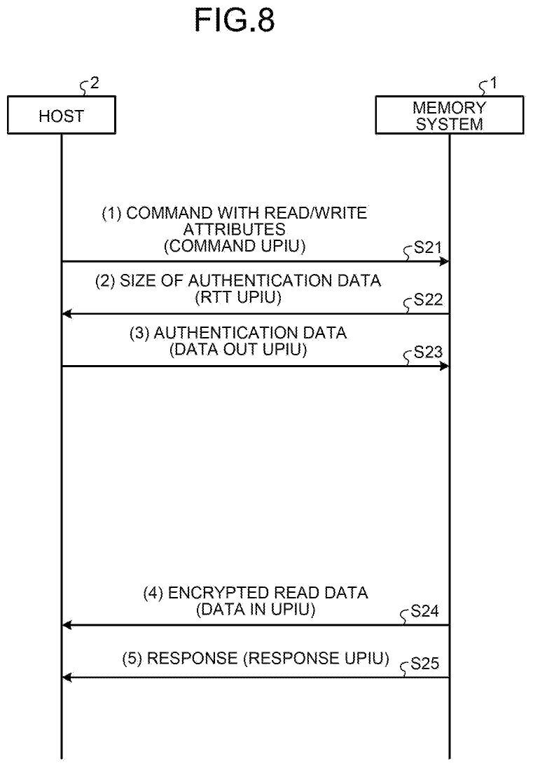

An operation of the information processing system 5 according to the second embodiment will now be described with reference to FIG. 8. FIG. 8 is a sequence diagram illustrating the operation of the information processing system 5 according to the second embodiment.

The host 2 first determines a logical address and the size of read data, and transmits a command to the memory system 1 using a COMMAND UPIU (step S21). This command has both a Read attribute and a Write attribute.

Upon receiving this command, the command reception module 151 of the memory system 1 transmits an RTT UPIU to the host 2 (step S22). The memory system 1 transmits the RTT UPIU to the host 2 to request the authentication data. As described above, the RTT UPIU specifies the size of data (here, the size of the authentication data) that the memory system 1 can receive at one time.

In response to the RTT UPIU, the host 2 transmits the authentication data to the memory system 1 using a DATA OUT UPIU (step S23). This DATA OUT UPIU may include the logical address and the size of the read data. The authentication data here is a one-time password, for example. The command reception module 151 of the memory system 1 acquires the authentication data. The acquisition module 152 reads the read data based on the logical address, and generates encrypted read data by encrypting the read data using the acquired one-time password. The output module 153 transmits the encrypted read data to the host 2 using a DATA IN UPIU (step S24). The command reception module 151 of the memory system 1 transmits a response using a RESPONSE UPIU to complete the process (step S25).

As described above, by using one command, the host 2 transmits the authentication data to the memory system 1, and the memory system 1 generates encrypted read data using the authentication data, and transmits the encrypted read data to the host 2. Thus, a read request can efficiently be processed by one command in the information processing system 5.

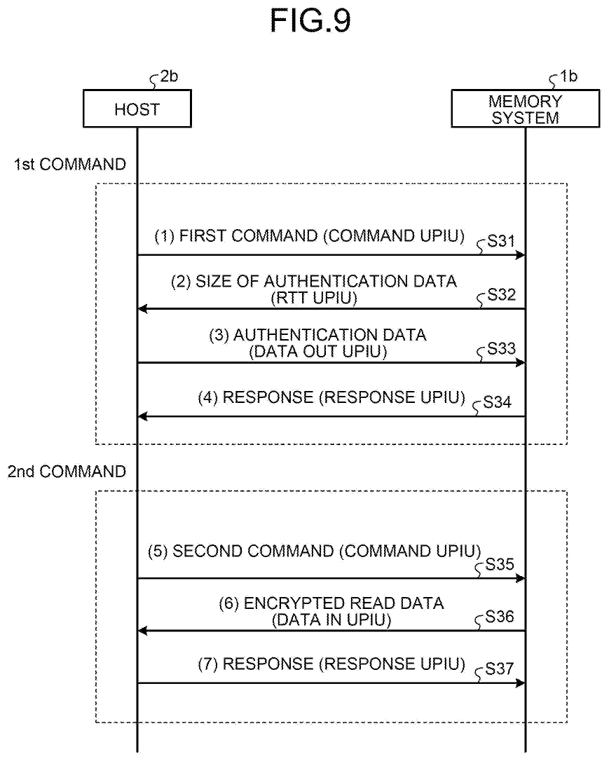

Here, a comparative example will be described. An information processing system 5b according to the comparative example includes a memory system 1b and a host 2b. In the comparative example, a command for transmitting authentication data to the memory system 1b and another command for transmitting encrypted read data to the host 2b are used. FIG. 9 is a sequence diagram illustrating an operation of the information processing system 5b according to the comparative example.

As illustrated in FIG. 9, the host 2b transmits a first command having a Write attribute to the memory system 1b using a COMMAND UPIU (step S31). Note that this first command has a Write attribute but does not have a Read attribute. Upon receiving this command, the memory system 1b transmits an RTT UPIU to the host 2b (step S32). In response to the RTT UPIU, the host 2b transmits the authentication data to the memory system 1b using a DATA OUT UPIU (step S33). The memory system 1b then transmits a response using a RESPONSE UPIU to complete the first command (step S34).

The host 2b then newly transmits a second command having a Read attribute to the memory system 1b using a COMMAND UPIU (step S35). The memory system 1b acquires read data and encrypts the read data using the authentication data that has been received in step S33. The memory system 1b then transmits the encrypted read data to the host 2b using a DATA IN UPIU (step S36). The memory system 1b finally transmits a response to the host 2b using a RESPONSE UPIU to complete the second command (step S37).

As in FIG. 7, the processes illustrated in FIG. 9 also have a problem that a large amount of command queues is consumed and a problem that the ordering between commands is need to be guaranteed.

On the other hand, according to the second embodiment, transmission/reception of the authentication data and transmission/reception of the encrypted read data are executed by one command. Therefore, the consumption of the command queue can be reduced as compared with the comparative example. Further, the processing for guaranteeing the execution order between commands is not required, and the processing can be performed efficiently.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a host including a processor; and
a memory system connected to the host, the memory system including a nonvolatile memory and a memory controller configured to control the nonvolatile memory, wherein
the processor of the host is configured to:
determine a logical address of read data and a size of the read data;
prepare third information related to the read data other than the logical address of the read data and the size of the read data, the third information being information necessary for the memory system to transmit the read data to the host; and
transmit, to the memory system, a command requesting to transmit the read data,
the memory controller of the memory system is further configured to:
in response to receiving the command from the host, transmit a request for the third information to the host,
the processor of the host is further configured to:
in response to receiving the request from the memory system, transmit the third information to the memory system, and
the memory controller of the memory system is further configured to:
by using the third information, acquire the read data from the nonvolatile memory and transmit the acquired read data to the host, without receiving another command from the host.

2. The information processing system according to claim 1, wherein
the third information includes mapping data for mapping the logical address of the read data and a physical address of a location of the nonvolatile memory in which the read data is stored, and
the memory controller of the memory system is configured to:
acquire the read data from the location of the nonvolatile memory specified in the mapping data.

3. The information processing system according to claim 2, wherein
the mapping data includes a plurality of entries each maps one physical address of the nonvolatile memory and one logical address among a plurality of logical addresses specified in the command.

4. The information processing system according to claim 1, wherein
the third information includes one-time password, and
the memory controller of the memory system is configured to:
acquire the read data from the nonvolatile memory and transmit the read data after encrypting the acquired read data by using the one-time password.

5. The information processing system according to claim 1, wherein
the command is based on Host Performance Booster Extension standard conforming to Universal Flash Storage standard.

6. The information processing system according to claim 1, wherein
the command has both a read attribute and a write attribute set therein.

7. The information processing system according to claim 6, wherein
the read attribute and the write attribute are set in a header of the command.

8. The information processing system according to claim 6, wherein
a bit value indicative of having the read attribute and a bit value indicative of having the write attribute are both set in the header of the command.

9. The information processing system according to claim 1, wherein
the memory controller of the memory system is further configured to specify, in the request, a size of the third information that is receivable at one time.

10. The information processing system according to claim 9, wherein
the processor of the host is further configured to:
when a size of the third information prepared by the processor of the host exceeds the size specified in the request, divide the third information and transmit the divided third information to the memory system, based on the size specified in the request.

11. A memory system connectable to a host, the memory system comprising:
a nonvolatile memory; and
a memory controller configured to:
in response to receiving, from the host, a command requesting to transmit read data, transmit a request for third information to the host, the third information relating to the read data other than a logical address of the read data and a size of the read data, the third information being information necessary for the memory controller to transmit the read data to the host; and
by using the third information that has been transmitted from the host in response to the request, acquire the read data from the nonvolatile memory and transmit the acquired read data to the host, without receiving another command from the host.

12. The memory system according to claim 11, wherein
the third information includes mapping data for mapping the logical address of the read data and a physical address of a location of the nonvolatile memory in which the read data is stored, and
the memory controller is configured to:
acquire the read data from the location of the nonvolatile memory specified in the mapping data.

13. The memory system according to claim 12, wherein
the mapping data includes a plurality of entries each maps one physical address of the nonvolatile memory and one logical address among a plurality of logical addresses specified in the command.

14. The memory system according to claim 11, wherein
the third information includes one-time password, and
the memory controller is configured to:
acquire the read data from the nonvolatile memory and transmit the read data after encrypting the acquired read data by using the one-time password.

15. The memory system according to claim 11, wherein
the command is based on Host Performance Booster Extension standard conforming to Universal Flash Storage standard.

16. The memory system according to claim 11, wherein
the command has both a read attribute and a write attribute set therein.

17. The memory system according to claim 16, wherein
the read attribute and the write attribute are set in a header of the command.

18. The memory system according to claim 16, wherein
a bit value indicative of having the read attribute and a bit value indicative of having the write attribute are both set in the header of the command.

19. The memory system according to claim 11, wherein
the memory controller is further configured to specify, in the request, a size of the third information that is receivable at one time.

20. The memory system according to claim 19, wherein
when a size of the third information prepared in the host exceeds the size specified in the request, the third information is divided by the host and the divided third information is transmitted to the memory system, based on the size specified in the request.
